(19) United States
(12) Patent Application Publication
(10) Pub. No.: US 2026/0020115 A1
(43) Pub. Date: Jan. 15, 2026

(54) FILM HEATER

(71) Applicant: DENSO CORPORATION, Kariya-city (JP)

(72) Inventors: Fuminobu MIKAMI, Kariya-city (JP); Koji OTA, Kariya-city (JP)

(21) Appl. No.: 19/338,921

(22) Filed: Sep. 24, 2025

Related U.S. Application Data
(63) Continuation of application No. PCT/JP2024/014706, filed on Apr. 11, 2024.

(30) Foreign Application Priority Data
Apr. 12, 2023 (JP) 2023-065039

(51) Int. Cl. H05B 3/84; H05B 3/03

(52) U.S. Cl. CPC H05B 3/84; H05B 3/03; H05B 2203/003

(57) ABSTRACT

A film heater includes a transparent conductive film, a first electrode and a second electrode. The transparent conductive film includes a first bottom extending in one direction, a second bottom facing the first bottom and having a length in the one direction longer than a length of the first bottom, and first and second oblique sides connected to the first bottom. The first electrode has a first connection connected to the first oblique side, and the second electrode has a second connection connected to the second oblique side. The transparent conductive film is configured to transmit electromagnetic waves and to generate heat when an electric current flows in the one direction through the transparent conductive film between the first and second connections, and the length of the first bottom in the one direction is longer than a shortest distance from the second bottom to the first and second connections.

### CROSS REFERENCE TO RELATED APPLICATION

The present application is a continuation application of International Patent Application No. PCT/JP2024/014706 filed on Apr. 11, 2024, which designated the U.S. and claims the benefit of priority from Japanese Patent Application No. 2023-065039 filed on Apr. 12, 2023. The entire disclosures of all of the above applications are incorporated herein by reference.

### TECHNICAL FIELD

The present disclosure relates to a film heater.

### BACKGROUND

Conventionally, a film heater is known, which has a hexagonal or trapezoidal-shaped transparent conductive film, a first connection connected to an oblique side of the transparent conductive film, and a second connection connected to a bottom side of the transparent conductive film. In such film heater, the transparent conductive film generates heat when an electric current flows through the transparent conductive film between the first and second connections.

### SUMMARY

According to an aspect of the present disclosure, a film heater includes a transparent conductive film, a first electrode and a second electrode. The transparent conductive film includes: a first bottom extending in one direction; a second bottom facing the first bottom in a direction perpendicular to both of the one direction and a thickness direction of the film heater, and having a length in the one direction longer than a length of the first bottom in the one direction; a first oblique side connected to the first bottom and extending in a direction that intersects with the one direction; and a second oblique side connected to the first bottom at one end opposite to an end to which the first oblique side is connected and extending in a direction that intersects with the one direction. The first electrode may have a first connection connected to the first oblique side, and the second electrode may have a second connection connected to the second oblique side. The transparent conductive film may be configured to transmit electromagnetic waves and to generate heat when an electric current flows in the one direction through the transparent conductive film between the first and second connections, and the length of the first bottom in the one direction is longer than a shortest distance from the second bottom to the first and second connections.

For example, an electrical resistance of an end of the first connection adjacent to the first bottom may be greater than an electrical resistance of an end of the first connection adjacent the second bottom. Alternatively, an electrical resistance of an end of the second connection adjacent to the first bottom may be greater than an electrical resistance of an end of the second connection adjacent to the second bottom.

### BRIEF DESCRIPTION OF THE DRAWINGS

Objects, features, and advantages of the present disclosure will become more apparent from the following detailed description made with reference to the accompanying drawings, in which:

FIG. 1 is a configuration diagram of a vehicle in which a film heater of a first embodiment is used;

FIG. 2 is an enlarged view along an arrow II in FIG. 1;

FIG. 3 is a front view of the film heater,

FIG. 4 is an enlarged cross-sectional view of a part taken along a line IV-IV in FIG. 3;

FIG. 5 is an enlarged view of a part V in FIG. 3;

FIG. 6 is an enlarged view of a part VI in FIG. 5;

FIG. 7 is an enlarged view of a part VII in FIG. 5;

FIG. 8 is an enlarged view of a part VIII in FIG. 5;

FIG. 9 is an enlarged view of a part IX in FIG. 5;

FIG. 10 is a front view of a film heater in a comparative example; and

FIG. 11 is a front view of a film heater of a second embodiment.

### EMBODIMENTS FOR CARRYING OUT INVENTION

A comparative film heater may be provided with a hexagonal or trapezoidal-shaped transparent conductive film, a first connection connected to an oblique side of the transparent conductive film, and a second connection connected to a bottom side of the transparent conductive film. In such film heater, the transparent conductive film generates heat when an electric current flows through the transparent conductive film between the first and second connections.

When a voltage applied to the transparent conductive film and an electrical resistance per unit area of the transparent conductive film are fixed, a power density, which is an electric power per unit area of the transparent conductive film, increases as a distance between the first and second connections decreases. Further, in the comparative film heater, the first connection is connected to an oblique side of the transparent conductive film, and the second connection is connected to a lower bottom of the transparent conductive film. Therefore, a distance between the first and second connections on a lower bottom side is shorter than a distance between the first and second connections on an upper bottom side. In such case, the power density between the first and second connections on the lower bottom side is higher than the power density between the first and second connections on the upper bottom side in the comparative film heater. Therefore, local heat generation is likely to occur in the transparent conductive film between the first and second connections on the lower bottom side.

It is an object of the present disclosure to provide a film heater that suppresses local heat generation of a transparent conductive films.

According to one aspect of the present disclosure, a film heater includes a transparent conductive film, a first electrode and a second electrode. The transparent conductive film includes: a first bottom extending in one direction; a second bottom facing the first bottom in a direction perpendicular to both of the one direction and a thickness direction of the film heater, and having a length in the one direction longer than a length of the first bottom in the one direction; a first oblique side connected to the first bottom and extending in a direction that intersects with the one direction; and a second oblique side connected to the first bottom at one end opposite to an end to which the first oblique side is connected and extending in a direction that intersects with the one direction. The first electrode has a first connection connected to the first oblique side, and the second electrode has a second connection connected to the second oblique side. The transparent conductive film is configured to transmit electromagnetic waves and to generate heat when an electric current flows in the one direction through the transparent conductive film between the first and second connections, and the length of the first bottom in the one direction is longer than a shortest distance from the second bottom to the first and second connections.

In such manner, the first bottom has a relatively great length, thereby preventing a distance between the first and second connections from becoming relatively small. Therefore, the power density in the transparent conductive film is prevented from becoming locally high between the first and second connections. Thus, local heat generation of the transparent conductive film can be suppressed.

Hereinafter, detail embodiments will be described with reference to the drawings. In the following embodiments, the same or equivalent portions are denoted by the same reference numerals, and the description thereof will be omitted.

### First Embodiment

In the present embodiment, a film heater suppresses local heat generation of a transparent conductive film. Specifically, film heaters are used, for example, in vehicles. First, one of such vehicles is explained.

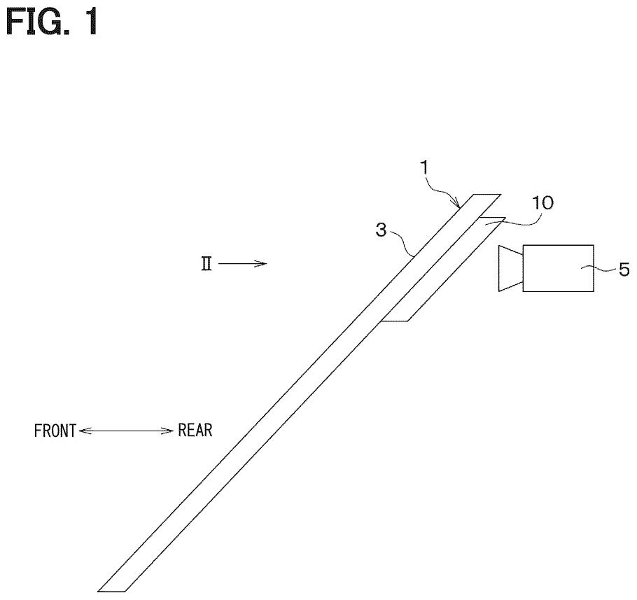

As shown in FIG. 1, a vehicle 1 includes a windshield 3, a camera 5, and a film heater 10.

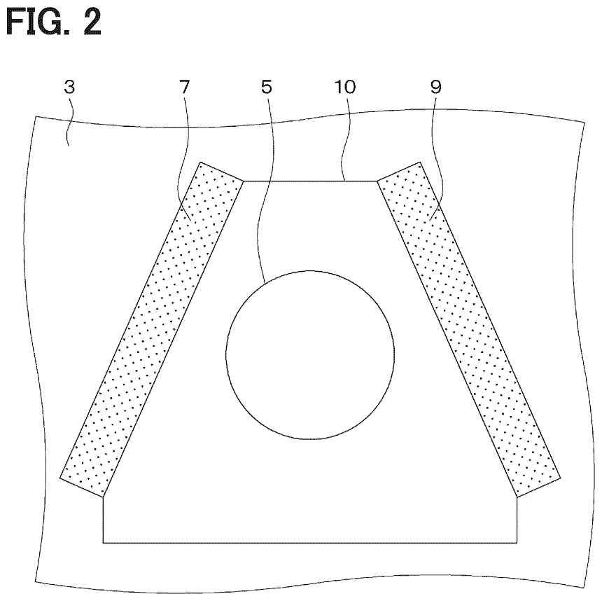

The windshield 3 corresponds to a transparent body that transmits electromagnetic waves such as radio waves, light and the like, and secures forward visibility of a driver of the vehicle 1. The windshield 3 also has a first shield unit 7 and a second shield unit 9, as shown in FIG. 2. The first shield unit 7 and the second shield unit 9 are formed of black ceramics or the like to shield electromagnetic waves. Furthermore, the first shield unit 7 and the second shield unit 9 are formed on the interior side of the vehicle 1 in the windshield 3. In FIG. 2, the first and second shield units 7 and 9 are shown with a dot pattern to make the location of the first and second shield units 7 and 9 easier to understand. Here, the first shield unit 7 and the second shield unit 9 are formed on one side of the windshield 3, i.e., on an interior side of the vehicle 1. However, without limiting the configuration to the one described above, the first shield unit 7 and the second shield unit 9 may be formed on an exterior side of the vehicle 1 on the windshield 3.

Returning to FIG. 1, the camera 5 is arranged in a cabin of the vehicle 1, e.g., on an upper side of the vehicle 1. Further, the camera 5 takes images of a front field of the vehicle 1.

The film heater 10 is attached on a cabin side of the windshield 3, along a slope of the windshield 3, and faces the camera 5 in a front-rear direction of the vehicle. Further, the film heater 10 generates heat to de-ice, melt snow, or de-fog a portion of the windshield 3 that faces the camera 5 in the front-rear direction of the vehicle. In such manner, a clear field of view is provided for the camera 5.

The vehicle 1 is configured as described above. The details of the film heater 10 are described next.

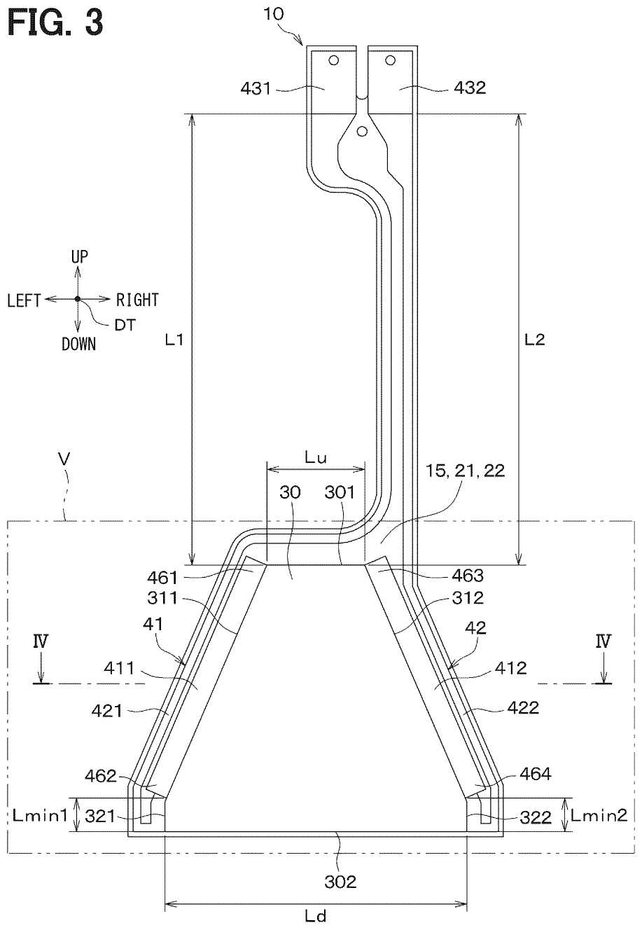

The film heater 10 has an adhesive layer 15, a first transparent insulator 21, a second transparent insulator 22, a transparent conductive film 30, a first electrode 41, and a second electrode 42, as shown in FIGS. 3 through 9. For the sake of clarity in explaining the configuration of the film heater 10, an upper side of the drawing in FIG. 3 is simply described as an upper side. A lower side of the drawing in FIG. 3 is simply described as a lower side. The left side of the drawing in FIG. 3 is simply described as the left side. The right side of the drawing in FIG. 3 is simply described as the right side.

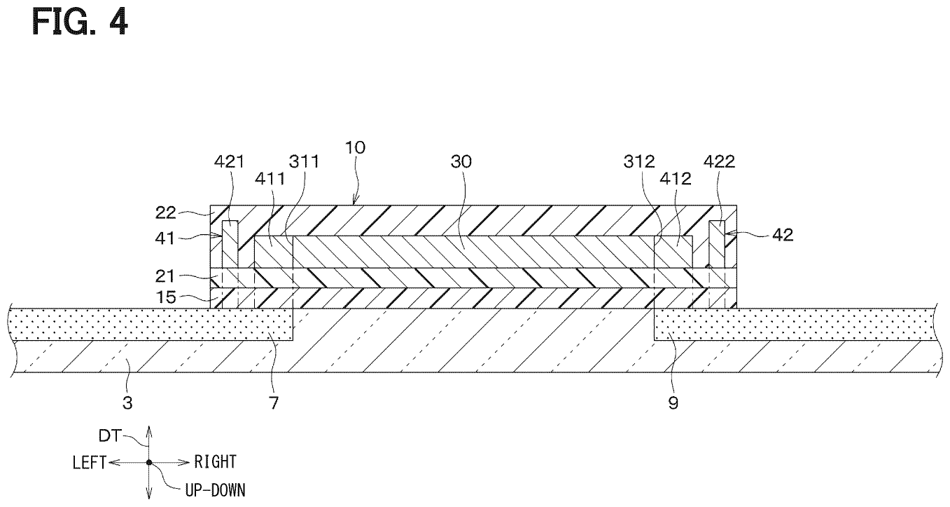

The adhesive layer 15 is formed by, for example, OCA or the like. Further, the adhesive layer 15 is attached to the cabin side of the windshield 3, as shown in FIG. 4. OCA is an abbreviation of Optically Clear Adhesive.

The first transparent insulator 21 and the second transparent insulator 22 are formed of a resin such as polycarbonate, which has electrical insulation properties. Further, the first transparent insulator 21 is connected to one side of the adhesive layer 15 opposite to the windshield 3.

The transparent conductive film 30 is formed by ITO, carbon nanotubes, or the like, and thus transmits electromagnetic waves and is conductive. ITO is an abbreviation of Indium Tin Oxide.

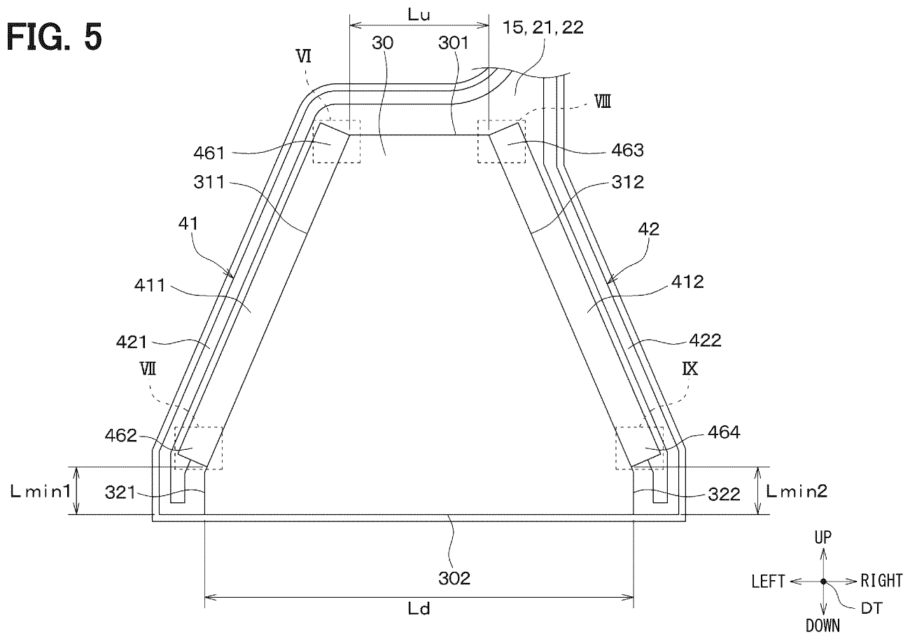

Further, the transparent conductive film 30 is covered by the first transparent insulator 21 and the second transparent insulator 22. The transparent conductive film 30 is formed in a plane shape. Further, the transparent conductive film 30 in the present embodiment is formed in a hexagonal shape. The transparent conductive film 30 has an upper bottom 301, a lower bottom 302, a first oblique side 311, a second oblique side 312, a first intermediate portion 321, and a second intermediate portion 322, as shown in FIGS. 3 and 5.

The upper bottom 301 corresponds to a first bottom, and extends in one direction, here in the left-right direction. The lower bottom 302 corresponds to a second bottom, and extends in one direction, here in the left-right direction. Further, the lower bottom 302 faces in a direction that is perpendicular to both of the one direction and a thickness direction DT of the transparent conductive film 30, in the present case, in an up-down direction. Note that the thickness direction DT of the transparent conductive film 30 corresponds to a thickness direction DT of the film heater 10.

The length of the upper bottom 301 in the left-right direction is defined as an upper bottom length Lu. The length of the lower bottom 302 in the left-right direction is defined as a lower bottom length Ld. Further, the lower bottom length Ld is longer than the upper bottom length Lu, i.e., Ld>Lu.

The first oblique side 311 is connected to the upper bottom 301. Further, the first oblique side 311 extends from a boundary with the upper bottom 301 in a direction that intersects with one direction, here, in a lower left direction.

The second oblique side 312 is connected to one end of the upper bottom 301 opposite to the end connected to the first oblique side 311. Further, the second oblique side 312 extends from a boundary with the upper bottom 301 in a direction that intersects with one direction, here, in a lower right direction.

The first intermediate portion 321 is connected to the opposite side of the first oblique side 311 from the upper bottom 301. Further, the first intermediate portion 321 extends from a boundary with the first oblique side 311 in a direction that intersects with one direction in which the first oblique side 311 extends, here, in a downward direction. Further, the first intermediate portion 321 is connected to the lower bottom 302.

The second intermediate portion 322 is connected to one end of the second oblique side 312 opposite to an end that is connected to the upper bottom 301. Further, the second intermediate portion 322 extends from a boundary with the second oblique side 312 in a direction that intersects with a direction in which the second oblique side 312 extends, for example, in a downward (lower) direction. The second intermediate portion 322 is connected to the opposite side of the lower bottom 302 from the first intermediate portion 321.

The first electrode 41 is formed of a metal such as gold, platinum, silver, copper, aluminum or the like. Further, the first electrode 41 is here a positive electrode. Further, the first electrode 41 has a first connection 411, a first lead 421, and a first terminal 431.

The first connection 411 is connected to (i) a boundary between the upper bottom 301 and the first oblique side 311 and to (ii) the first oblique side 311. Further, the first connection 411 is covered by the first transparent insulator 21 and the second transparent insulator 22. Here, a first shortest distance Lmin1 from the first connection 411 to the lower bottom 302 is longer than zero due to the first intermediate portion 321. Further, the first shortest distance Lmin1 is shorter than the upper bottom length Lu, i.e., Lmin1<Lu.

The first connection 411 overlaps a projected first shield unit 7 when the first shield unit 7 is projected in the thickness direction DT, as shown in FIG. 4. In FIG. 4, the first shield unit 7 is shown as a dot pattern, for making the location of the first shield unit 7 easier to understand.

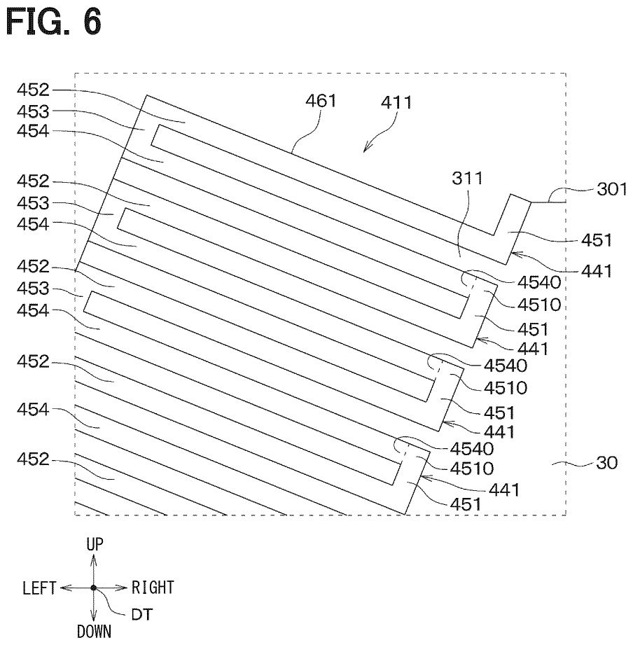

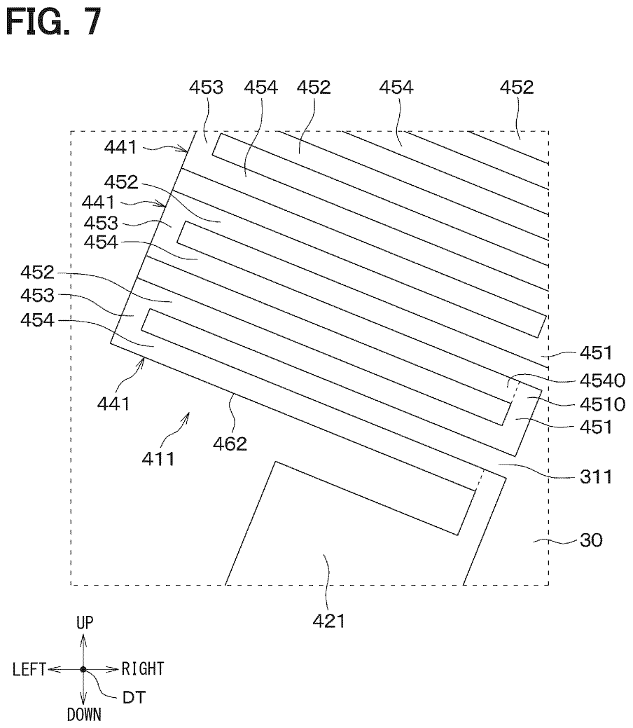

Further, the first connection 411 has a plurality of first wavy sections 441, as shown in FIGS. 6 and 7. The first wavy sections 441 are connected and lined up with each other. Further, the first wavy section 441 includes a first extension 451, a second extension 452, a third extension 453, and a fourth extension 454.

The first extension 451 extends in a direction in which a surface of the transparent conductive film 30 extends, i.e., in the present case, from the upper bottom 301 toward the lower left. The second extension 452 is connected to the first extension 451. Further, the second extension 452 extends from a boundary with the first extension 451 in a direction that intersects with the direction in which the first extension 451 extends, here, toward the upper left. The third extension 453 is connected to the second extension 452. Further, the third extension 453 extends from a boundary with the second extension 452 in a direction that intersects with the direction in which the second extension 452 extends, in the present case, in the lower left direction. The fourth extension 454 is connected to the third extension 453. Further, the fourth extension 454 extends from a boundary with the third extension 453 in a direction that intersects with the direction in which the third extension 453 extends, here, in the lower right direction. In such manner, the second extensions 452 face with each other in the direction in which the fourth extension 454 and the first extension 451 extend, in the present case, in the lower left direction. Note that the first extension 451, the second extension 452, the third extension 453 and the fourth extension 454 are not limited to the one extending in a straight-line shape. However, such a configuration is not a limiting one. The first extension 451, the second extension 452, the third extension 453 and the fourth extension 454 may extend in a curved-line shape.

An end 4540 of the fourth extension 454, which is an end on an opposite side to the third extension 453, is connected to an end 4510 of the first extension 451 in an adjacent first wavy section 441, which is an end on an opposite side to the second extension 452. In such manner, the first wavy sections 441 adjacent to each other are connected and lined up. Thus, the first connection 411 has a serpentine shape.

Further, a part of the first wavy section 441 on a most upper bottom 301 side is defined as a first end 461, as shown in FIGS. 3, 5 and 6. Further, a part of the first wavy section 441 on a most bottom 302 side is defined as a second end 462, as shown in FIGS. 3, 5 and 7. Further, for example, the conductivity of the first end 461 is lower than that of the second end 462. Further, the length of the path of the electric current flowing through the first end 461 is longer than the length of the path of the electric current flowing through the second end 462. Further, a cross-sectional area of the first end 461 when the first end 461 is cut in the direction perpendicular to the direction of the electric current flowing through the first end 461 is smaller than a cross-sectional area of the second end 462 when the second end 462 is cut in the direction perpendicular to the direction of the electric current flowing through the second end 462. Therefore, an electrical resistance of the first end 461 is greater than that of the second end 462.

The first lead 421 is connected to the lower bottom 302 and the first intermediate portion 321, as shown in FIGS. 3 and 5. Further, the first lead 421 is connected to a lower bottom 302 side of the first connection 411. The first lead 421 is not limited to being connected to the lower bottom 302, the first intermediate portion 321, and the lower bottom 302 side of the first connection 411, but may be connected to an upper bottom 301 side of the first connection 411.

Further, the first lead 421 is covered by the first transparent insulator 21 and the second transparent insulator 22. Further, the first lead 421 overlaps the projected first shield unit 7 when the first shield unit 7 is projected in the thickness direction DT, as shown in FIG. 4. Returning to FIGS. 3 and 5, the first lead 421, together with a second lead 422 to be described later, extends to surround the transparent conductive film 30, the first connection 411, and the second connection 412. In such manner, the first lead 421 faces the first connection 411 in the left-right direction, and faces the upper bottom 301 in the up-down direction.

The first terminal 431 is connected to the first lead 421, as shown in FIG. 3. The first terminal 431 is connected to a power source, which is not shown.

The length from the first terminal 431 to the upper bottom 301 in a direction perpendicular to both of one direction and the thickness direction DT, in the present case, in the up-down direction, is defined as a first lead length L1. The first lead length L1 is longer than the upper bottom length Lu, i.e., L1>Lu.

The second electrode 42 is formed of a metal such as gold, platinum, silver, copper, aluminum or the like. Further, the second electrode 42 is here a negative electrode. Further, the second electrode 42 has a second connection 412, a second lead 422, and a second terminal 432.

The second connection 412 is connected to a boundary between the upper bottom 301 and the second oblique side 312, and to the second oblique side 312. Further, the second connection 412 is covered by the first transparent insulator 21 and the second transparent insulator 22. Here, a second shortest distance Lmin2 from the second connection 412 to the lower bottom 302 is greater than zero due to the second intermediate portion 322. Further, the second shortest distance Lmin2 is set equal to the first shortest distance Lmin1, and is shorter than the upper bottom length Lu, i.e., Lmin1=Lmin2<Lu. The second shortest distance Lmin2 is not limited to being the same as the first shortest distance Lmin1, but may be different from the first shortest distance Lmin1.

Further, the second connection 412 overlaps the projected second shield unit 9 when the second shield unit 9 is projected in the thickness direction DT, as shown in FIG. 4. In FIG. 4, the second shield unit 9 is shown as a dot pattern to make the location of the second shield unit 9 easier to understand.

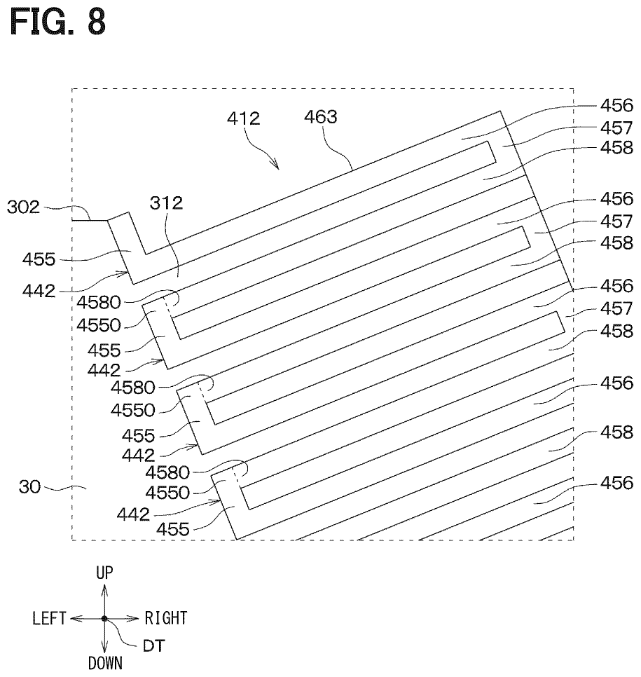

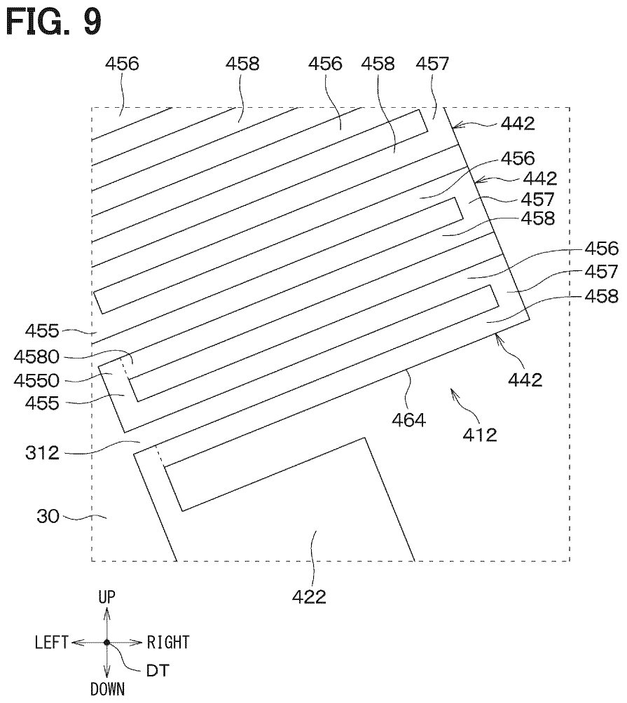

Further, the second connection 412 has a plurality of second wavy sections 442, as shown in FIGS. 8 and 9. The second wavy sections 442 are connected and lined up with each other. Further, the second wavy section 442 includes a fifth extension 455, a sixth extension 456, a seventh extension 457, and an eighth extension 458.

The fifth extension 455 extends in a direction in which the surface of the transparent conductive film 30 extends, in the present case, from the upper bottom 301 toward the lower right. The sixth extension 456 is connected to the fifth extension 455. Further, the sixth extension 456 extends from a boundary with the fifth extension 455 in a direction that intersects with the direction in which the fifth extension 455 extends, here, toward the upper right. The seventh extension 457 is connected to the sixth extension 456. Further, the seventh extension 457 extends from a boundary with the sixth extension 456 in a direction that intersects with the direction in which the sixth extension 456 extends, here, in the lower right direction. The eighth extension 458 is connected to the seventh extension 457. Further, the eighth extension 458 extends from a boundary with the seventh extension 457 in a direction that intersects with the direction in which the seventh extension 457 extends, here, in the lower left direction. In such manner, the sixth extensions 456 face with each other in the direction in which the eighth extension 458 and the fifth extension 455 extend, here, in the lower right direction. Note that the fifth extension 455, the sixth extension 456, the seventh extension 457, and the eighth extension 458 are not limited to the one extending in a straight-line shape. However, such a configuration is not a limiting one. The fifth extension 455, the sixth extension 456, the seventh extension 457, and the eighth extension 458 may extend in a curved-line shape.

An end 4580 of the eighth extension 458, which is an end on an opposite side to the seventh extension 457, is connected to an end 4550 of the fifth extension 455 in an adjacent second wavy section 442, which is an end on an opposite side to the sixth extension 456. In such manner, the second wavy sections 442 adjacent to each other are connected and lined up. Thus, the second connection 412 has a serpentine shape.

Further, a part of the second wavy section 442 on the most upper bottom 301 side is defined as a third end 463, as shown in FIGS. 3, 5 and 8. Further, as shown in FIGS. 3, 5 and 9, a part of the second wavy section 442 on the most bottom 302 side is defined as a fourth end 464. Further, for example, the conductivity of the third end 463 is lower than that of the fourth end 464. Further, the length of the path of the electric current flowing through the third end 463 is longer than the length of the path of the electric current flowing through the fourth end 464. Further, a cross-sectional area of the third end 463 when the third end 463 is cut in the direction perpendicular to the direction of the electric current flowing through the third end 463 is smaller than a cross-sectional area of the fourth end 464 when the fourth end 464 is cut in the direction perpendicular to the direction of the electric current flowing through the fourth end 464. Therefore, an electrical resistance of the third end 463 is greater than that of the fourth end 464.

The second lead 422 is connected to the lower bottom 302 and the second intermediate portion 322, as shown in FIGS. 3 and 5. Further, the second lead 422 is connected to the lower bottom 302 side of the second connection 412. The second lead 422 is not limited to being connected to the lower bottom 302, the second intermediate portion 322, and the lower bottom 302 side of the second connection 412, but may be connected to the upper bottom 301 side of the second connection 412.

The second lead 422 is covered by the first transparent insulator 21 and the second transparent insulator 22. Further, the second lead 422 overlaps the projected second shield unit 9 when the second shield unit 9 is projected in the thickness direction DT, as shown in FIG. 4. Returning to FIGS. 3 and 5, the second lead 422, together with the first lead 421, extends to surround the transparent conductive film 30, the first connection 411, and the second connection 412. In such manner, the second lead 422 faces the second connection 412 in the left-right direction.

The second terminal 432 is connected to the second lead 422, as shown in FIG. 3. Further, the second terminal 432 is connected to the power source, which is not shown.

The length from the second terminal 432 to the upper bottom 301 in a direction perpendicular to both of one direction and the thickness direction DT, in the present case, in the up-down direction, is defined as a second lead length L2. Further, the second lead length L2 is set equal to the first lead length L1, and is longer than the upper bottom length Lu, i.e., L1=L2>Lu. Note that the second lead length L2 is not limited to being the same as the first lead length L1, but may be different from the first lead length L1.

As described above, the film heater 10 of the first embodiment is configured. Next, the heat generation by the film heater 10 is explained.

Here, the first electrode 41 is the positive electrode and the second electrode 42 is the negative electrode. Therefore, when a power source, not shown, supplies electric power to the film heater 10, electric current flows from the power source, not shown, to the first connection 411 via the first terminal 431 and the first lead 421. Further, electric current flows from the first connection 411 to the second connection 412 via the transparent conductive film 30. In such a situation, electric current flows through the transparent conductive film 30 in one direction, in the present case, toward the right. In such manner, the transparent conductive film 30 generates heat.

As described above, the film heater 10 generates heat. Next, suppression of local heat generation in the transparent conductive film 30 is explained.

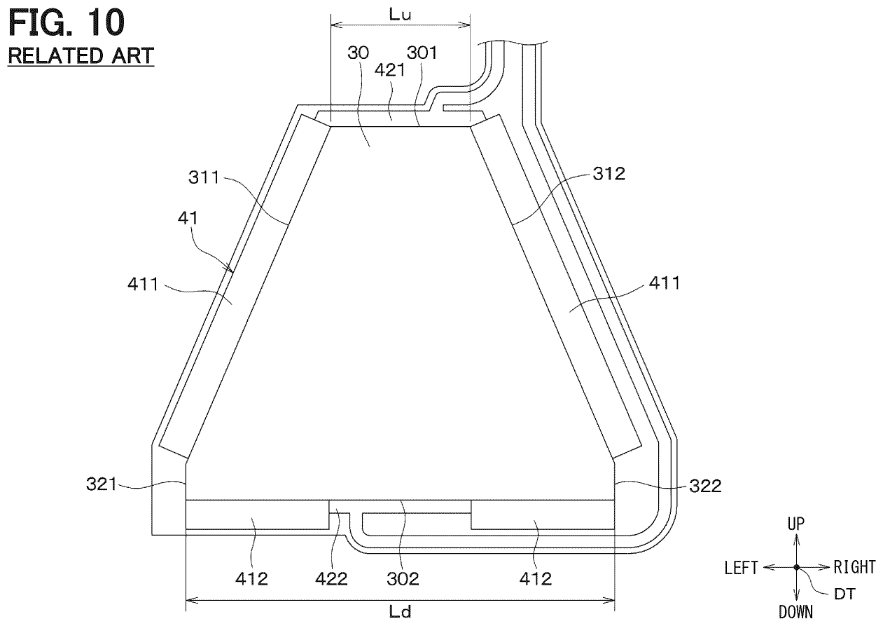

FIG. 10 shows, as a comparative example film heater, a configuration in which the first connection 411 is connected to the first and second oblique sides 311 and 312. Suppose that the first lead 421 is connected to the upper bottom 301 and the first connection 411. Suppose further that the second connection 412 is connected to a part of the lower bottom 302. Suppose yet further that the second lead 422 is connected to the lower bottom 302 and the second connection 412. In such case, when the power source, not shown, supplies electric power to the film heater 10, the transparent conductive film 30 generates heat as electric current flows in a downward direction through the transparent conductive film 30 between the first and second connections 411 and 412. However, in the present case, in the up-down direction, a distance between the first and second connections 411 and 412 on the lower bottom 302 side is shorter than a distance between the first and second connections 411 and 412 on the upper bottom 301 side.

Further, here, an electric power density Wp, which is electric power per unit area, is expressed as in the following equation (1). Therefore, when a voltage applied to the transparent conductive film 30 and a sheet resistance of the transparent conductive film 30 are fixed, the electric power density Wρ increases as the distance between the first and second connections 411 and 412 decreases. V is a voltage applied to the transparent conductive film 30. Rs is a sheet resistance of the transparent conductive film 30. The sheet resistance is an electrical resistance per unit area. H is a distance between the first and second connections 411 and 412.

$$W ρ = \frac{{V}^{2}}{Rs \times {H}^{2}} \qquad ( Equation 1 )$$

Thus, in the comparative example film heater of FIG. 10, the distance between the first and second connections 411 and 412 on the lower bottom 302 side is shorter than the distance between the first and second connections 411 and 412 on the upper bottom 301 side, as described above. Further, the voltage applied to the transparent conductive film 30 and the sheet resistance of the transparent conductive film 30 are fixed. Thus, in the present case, the electric power density Wρ between the first and second connections 411 and 412 on the lower bottom 302 side is higher than the electric power density Wρ between the first and second connections 411 and 412 on the upper bottom 301 side in the comparative example film heater. Therefore, local heat generation is likely to occur in the transparent conductive film 30 between the first and second connections 411 and 412 on the lower bottom 302 side.

In contrast, in the film heater 10 of present embodiment, the lower bottom length Ld is longer than the upper bottom length Lu, i.e., the upper bottom length Lu is shorter than the lower bottom length Ld, as shown in FIGS. 3 and 5. Further, the first connection 411 is connected to the first oblique side 311. Further, the second connection 412 is connected to the second oblique side 312. Still further, the transparent conductive film 30 heats up when electric current flows in one direction, here in the right direction, between the first and second connections 411 and 412. Still yet further, the upper bottom length Lu is longer than the first and second shortest distances Lmin1 and Lmin2. The upper bottom length Lu corresponds to the length of the first bottom in one direction. The lower bottom length Ld corresponds to the length of the second bottom in one direction. Still yet further, the first shortest distance Lmin1 and the second shortest distance Lmin2 correspond to the shortest distances from the second bottom to the first connection 411 and the second connection 412.

In such manner, the distances between the first and second connections 411 and 412 are prevented from becoming relatively small due to the upper bottom length Lu being relatively large. Thus, the electric power density Wρ in the transparent conductive film 30 between the first and second connections 411 and 412 is prevented from becoming locally high. Thus, local heat generation in the transparent conductive film 30 is suppressed.

The film heater 10 of the first embodiment further achieves the following effects.
[1] When the film heater 10 is viewed from the outside, the first connection 411, the second connection 412, the first lead 421, and the second lead 422 are formed of metals such as gold, platinum, silver, copper, aluminum or the like, and thus stand out in appearance from the transparent conductive film 30.

Based on the above, in the film heater 10 of the present embodiment, as shown in FIG. 4, the first connection 411 overlaps the projected first shield unit 7 when the first shield unit 7 is projected in the thickness direction DT. Further, the second connection 412 overlaps the projected second shield unit 9 when the second shield unit 9 is projected in the thickness direction DT. Further, the first lead 421 overlaps the projected first shield unit 7 when the first shield unit 7 is projected in the thickness direction DT. Further, the second lead 422 overlaps the projected second shield unit 9 when the second shield unit 9 is projected in the thickness direction DT.

In such manner, the first connection 411, the second connection 412, the first lead 421, and the second lead 422 become less visible when the film heater 10 is viewed from the outside, since they are hidden by the first and second shield units 7 and 9. Therefore, the first connection 411, the second connection 412, the first lead 421, and the second lead 422 are prevented from standing out in appearance. Thus, deterioration of the film heater 10 in terms of design perspective is suppressed.
[2] The first and second lead lengths L1 and L2 are longer than the upper bottom length Lu. The first lead length L1 and second lead length L2 correspond to the lengths from the first terminal 431 and second terminal 432 to the first bottom in the direction that is perpendicular to both of the one direction and the thickness direction DT.

In such manner, a relatively large space is reserved between (i) the upper bottom 301 and (ii) the first terminal 431 and the second terminal 432. Thus, such configuration makes it easy, for example, for the peripheral components, the peripheral equipment and the like related to the camera 5 to be arranged at a position between (i) the upper bottom 301 and (ii) the first terminal 431 and the second terminal 432. Thus, the mountability of the peripheral components and the peripheral equipment is improved.
[3] The electrical resistance of the first end 461 is greater than that of the second end 462. The electrical resistance of the third end 463 is greater than that of the fourth end 464. The first end 461 corresponds to the end of the first connection 411 on the first bottom side. The second end 462 corresponds to the end of the first connection 411 on the second bottom side. The third end 463 corresponds to the end of the second connection 412 on the first bottom side. The fourth end 464 corresponds to the end of the second connection 412 on the second bottom side.

In such manner, the electrical resistance between the first and second connections 411 and 412 on the upper bottom 301 side is greater than the electrical resistance between the first and second connections 411 and 412 on the lower bottom 302 side. Therefore, electric current is less likely to flow between the first and second connections 411 and 412 on the upper bottom 301 side than between the first and second connections 411 and 412 on the lower bottom 302 side. Therefore, the amount of heat generated between the first and second connections 411 and 412 on the upper bottom 301 side is smaller than that between the first and second connections 411 and 412 on the lower bottom 302 side. Further, the upper bottom length Lu is shorter than the lower bottom length Ld. Thus, the variation in the amount of heat generated per unit length in the transparent conductive film 30 is reduced. Such a configuration facilitates uniform temperature within the transparent conductive film 30. Thus, temperature variation within the transparent conductive film 30 is reduced.
[4] The first connection 411 has a plurality of the first wavy sections 441 that are connected and lined up with each other. Further, the second connection 412 has a plurality of the second wavy sections 442 that are connected and lined up with each other.

In such manner, when the length of the first oblique side 311 is fixed, the length of the path of the electric current flowing through the first connection 411 is made longer, compared to a case when the first connection 411 has a uniformly planar shape extending in the direction along the first oblique side 311. Further, when the length of the second oblique side 312 is fixed, the length of the path of the electric current flowing through the second connection 412 is made longer, compared to a case when the second connection 412 has a uniformly planar shape extending in the direction along the second oblique side 312. Thus, it is easier to adjust the length of the path of the electric current flowing through the first and second connections 411 and 412. Thus, it is easier to adjust the electrical resistance of the first and second connections 411 and 412.

### Second Embodiment

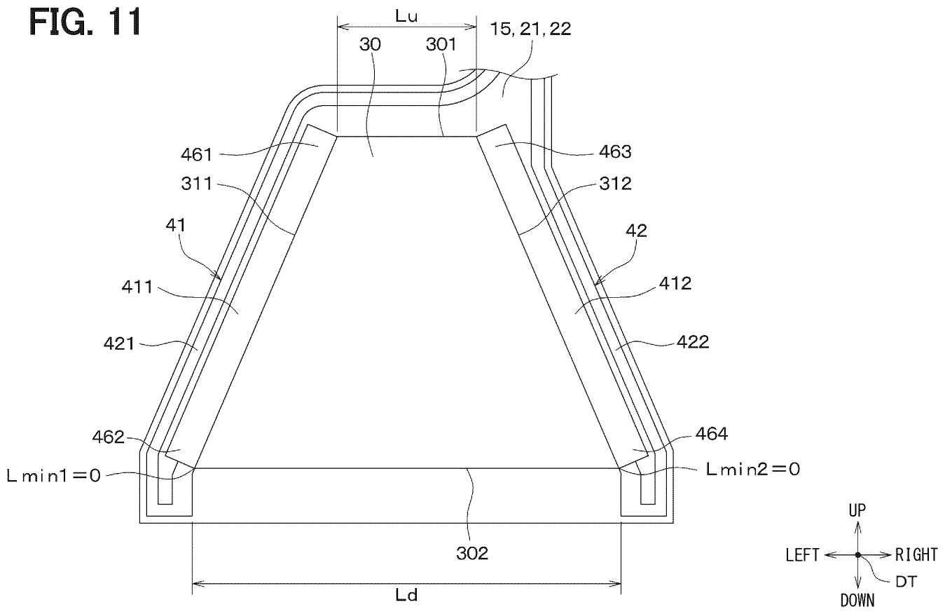

In the second embodiment, as shown in FIG. 11, a transparent conductive film 30 does not have a first intermediate portion 321 and a second intermediate portion 322, and a lower bottom 302 is connected to first and second oblique sides 311 and 312. Therefore, the transparent conductive film 30 is formed in a trapezoidal shape. In addition to that a first connection 411 is connected (i) to a boundary between the upper bottom 301 and the first oblique side 311 and (ii) to the first oblique side 311, the first connection 411 is connected to a boundary between the first oblique side 311 and the lower bottom 302. Further, in addition to that a second connection 412 is connected (i) to a boundary between the upper bottom 301 and the second oblique side 312 and (ii) to the second oblique side 312, the second connection 412 is connected to a boundary between the second oblique side 312 and the lower bottom 302. Therefore, a first shortest distance Lmin1 and a second shortest distance Lmin2 are set to zero.

As described above, the film heater 10 of the second embodiment is configured. The second embodiment achieves effects similar to the effects achieved by the first embodiment.

### Other Embodiments

The present disclosure is not limited to the above-described embodiments, and the above-described embodiments are appropriately modifiable. Further, individual elements or features of a particular embodiment are not necessarily essential unless it is specifically stated that the elements or the features are essential in the foregoing description, or unless the elements or the features are obviously essential in principle.

In each of the above-described embodiments, the film heater 10 performs de-icing, snow melting and de-fogging of the windshield 3, but is not limited to such a configuration. The film heater 10 may perform de-icing, snow melting and de-fogging of a radar device, a lidar, and headlights and the like, which are not shown in the drawing, mounted on the vehicle 1. Lidar is an abbreviation of Light Detection and Ranging/Laser Imaging Detection and Ranging.

Further, the film heater 10 is not limited to use in the vehicle 1, but may be used, for example, in an equipment or the like not shown.

In each of the above-described embodiments, the upper bottom 301 is connected to the first oblique side 311. In contrast, at a position between the upper bottom 301 and the first oblique side 311, an intermediate portion may be formed, which is connected to the upper bottom 301 and to the first oblique side 311 and extends in a direction that intersects with the direction in which the upper bottom 301 and the first oblique side 311 extend.

Further, the upper bottom 301 and the second oblique side 312 are connected. In contrast, at a position between the upper bottom 301 and the second oblique side 312, an intermediate portion may be formed, which is connected to the upper bottom 301 and to the second oblique side 312 and extends in a direction that intersects with the direction in which the upper bottom 301 and the second oblique side 312 extend.

In each of the above-described embodiments, the first electrode 41 is the positive electrode and the second electrode 42 is the negative electrode. In contrast, the first electrode 41 may be the negative electrode and the second electrode 42 may be the positive electrode.

In each of the above-described embodiments, the first and second connections 411 and 412 are formed in a serpentine shape by having the first and second wavy portions 441 and 442, respectively. In contrast, the first and second connections 411 and 412 are not limited to being formed in a serpentine shape. The first connection 411 may be formed in a uniform planar or other shape extending in a direction along the first oblique side 311. The second connection 412 may be formed in a uniform planar or other shape extending in a direction along the second oblique side 312. Further, the corners of the first and second wavy sections 441 and 442 may be C-chamfered or R-chamfered.

The embodiments described above may also be combined with each other as appropriate.

### VARIOUS EXEMPLARS OF THE PRESENT DISCLOSURE

### Exemplar 1

A film heater includes a transparent conductive film (30), a first electrode (41) and a second electrode (42). The transparent conductive film (30) includes: a first bottom (301) extending in one direction; a second bottom (302) facing the first bottom in a direction perpendicular to both of the one direction and a thickness direction (DT) of the film heater, and having a length (Ld) in the one direction longer than a length (Lu) of the first bottom in the one direction; a first oblique side (311) connected to the first bottom and extending in a direction that intersects with the one direction; and a second oblique side (312) connected to the first bottom at one end opposite to an end to which the first oblique side is connected and extending in a direction that intersects with the one direction. The first electrode (41) having a first connection (411) connected to the first oblique side, and the second electrode (42) having a second connection (412) connected to the second oblique side. The transparent conductive film is configured to transmit electromagnetic waves and to generate heat when an electric current flows in the one direction through the transparent conductive film between the first and second connections, and the length (Lu) of the first bottom in the one direction is longer than a shortest distance (Lmin1, Lmin2) from the second bottom to the first and second connections.

### Exemplar 2

In the film heater of exemplar 1, the film heater is attached to a transparent body (3) that transmits electromagnetic waves, the transparent body includes a first shield unit (7) and a second shield unit (9) respectively shielding electromagnetic waves, the first connection overlaps a projected portion of the first shield unit when the first shield unit is projected in the thickness direction, and the second connection overlaps a projected portion of the second shield unit when the second shield unit is projected in the thickness direction.

### Exemplar 3

In the film heater of exemplar 1 or 2, the first electrode includes a first lead (421) connected to the first connection, and a first terminal (431) connected to the first lead and connected to a power source, the second electrode includes a second lead (422) connected to the second connection, and a second terminal (432) connected to the second lead and to the power source, and the lengths (L1, L2) from the first and second terminals to the first bottom in a direction perpendicular to both of the one direction and the thickness direction are longer than the length (Lu) of the first bottom in the one direction.

### Exemplar 4

In the film heater of any one of exemplars 1 to 3, an electrical resistance of an end (461) of the first connection adjacent to the first bottom is greater than an electrical resistance of an end (462) of the first connection adjacent the second bottom.

### Exemplar 5

In the film heater of any one of exemplars 1 to 4, an electrical resistance of an end (463) of the second connection adjacent to the first bottom is greater than an electrical resistance of an end (464) of the second connection adjacent to the second bottom.

### Exemplar 6

In the film heater of any one of exemplars 1 to 5, the first connection includes a plurality of wavy sections (441) connected and lined up with each other. The plurality of wavy sections includes: a first extension (451) extending in a direction in which a surface of the transparent conductive film extends; a second extension (452) connected to the first extension and extending in a direction that intersects with the direction in which the first extension extends; a third extension (453) connected to the second extension and extending in a direction that intersects with the direction in which the second extension extends; and a fourth extension (454) connected to the third extension and extending in a direction that intersects with the direction in which the third extension extends, the fourth extension facing the second extension and the first extension extend. In addition, the plurality of wavy sections adjacent to each other are connected and lined up by connection of (i) an end (4540) of the fourth extension on an opposite side of the third extension and (ii) an end (4510) of the first extension on an opposite side to the second extension.

### Exemplar 7

In the film heater of exemplar 6, the wavy section is a first wavy section, and the second connection has a plurality of second wavy sections (442) connected and lined up with each other. The second wavy section includes a fifth extension (455) extending in a direction in which the surface of the transparent conductive film extends, a sixth extension (456) connected to the fifth extension and extending in a direction that intersects with the direction in which the fifth extension extends, a seventh extension (457) connected to the sixth extension and extending in a direction that intersects with the direction in which the sixth extension extends, and an eighth extension (458) connected to the seventh extension and extending in a direction that intersects with the direction in which the seventh extension extends, to face in the direction in which the sixth and fifth extensions extend. In addition, the plurality of second wavy sections adjacent to each other are connected and lined up by connection of (i) an end (4580) of the eighth extension on an opposite side of the seventh extension and (ii) an end (4550) of the fifth extension on an opposite side of the sixth extension.

### Exemplar 8

In the film heater of any one of exemplars 1, 4 to 7, the film heater is attached to a transparent body (3) that transmits electromagnetic waves, and the transparent body has a first shield unit (7) and a second shield unit (9) that shield electromagnetic waves. The first electrode includes a first lead (421) connected to the first connection, and a first terminal (431) connected to the first lead and connected to a power source. The second electrode includes a second lead (422) connected to the second connection, and a second terminal (432) connected to the second lead and to the power source. In this case, the first lead overlaps a projected first shield unit when the first shielding portion is projected in the thickness direction, and the second lead overlaps a projected second shield unit when the second shield unit is projected in the thickness direction.

What is claimed is:

1. A film heater comprising:
a transparent conductive film including:
a first bottom extending in one direction;
a second bottom facing the first bottom in a direction perpendicular to both of the one direction and a thickness direction of the film heater, and having a length in the one direction longer than a length of the first bottom in the one direction;
a first oblique side connected to the first bottom and extending in a direction that intersects with the one direction; and
a second oblique side connected to the first bottom at one end opposite to an end to which the first oblique side is connected and extending in a direction that intersects with the one direction;
a first electrode having a first connection connected to the first oblique side; and
a second electrode having a second connection connected to the second oblique side, wherein
the transparent conductive film is configured to transmit electromagnetic waves and to generate heat when an electric current flows in the one direction through the transparent conductive film between the first and second connections,
the length of the first bottom in the one direction is longer than a shortest distance from the second bottom to the first and second connections, and
an electrical resistance of an end of the first connection adjacent to the first bottom is greater than an electrical resistance of an end of the first connection adjacent the second bottom.

2. A film heater comprising:
a transparent conductive film including:
a first bottom extending in one direction;
a second bottom facing the first bottom in a direction perpendicular to both of the one direction and a thickness direction of the film heater, and having a length in the one direction longer than a length of the first bottom in the one direction;
a first oblique side connected to the first bottom and extending in a direction that intersects with the one direction; and
a second oblique side connected to the first bottom at one end opposite to an end to which the first oblique side is connected and extending in a direction that intersects with the one direction;
a first electrode having a first connection connected to the first oblique side; and
a second electrode having a second connection connected to the second oblique side, wherein
the transparent conductive film is configured to transmit electromagnetic waves and to generate heat when an electric current flows in the one direction through the transparent conductive film between the first and second connections,
the length of the first bottom in the one direction is longer than a shortest distance from the second bottom to the first and second connections, and
an electrical resistance of an end of the second connection adjacent to the first bottom is greater than an electrical resistance of an end of the second connection adjacent to the second bottom.

3. A film heater comprising:
a transparent conductive film including:
a first bottom extending in one direction;
a second bottom facing the first bottom in a direction perpendicular to both of the one direction and a thickness direction of the film heater, and having a length in the one direction longer than a length of the first bottom in the one direction;
a first oblique side connected to the first bottom and extending in a direction that intersects with the one direction; and
a second oblique side connected to the first bottom at one end opposite to an end to which the first oblique side is connected and extending in a direction that intersects with the one direction;
a first electrode having a first connection connected to the first oblique side; and
a second electrode having a second connection connected to the second oblique side, wherein
the transparent conductive film is configured to transmit electromagnetic waves and to generate heat when an electric current flows in the one direction through the transparent conductive film between the first and second connections,
the length of the first bottom in the one direction is longer than a shortest distance from the second bottom to the first and second connections,
the first connection includes a plurality of wavy sections connected and lined up with each other,
the plurality of wavy sections includes:
a first extension extending in a direction in which a surface of the transparent conductive film extends;
a second extension connected to the first extension and extending in a direction that intersects with the direction in which the first extension extends;
a third extension connected to the second extension and extending in a direction that intersects with the direction in which the second extension extends; and
a fourth extension connected to the third extension and extending in a direction that intersects with the direction in which the third extension extends, the fourth extension facing the second extension and the first extension extend, and
the plurality of wavy sections adjacent to each other are connected and lined up by connection of (i) an end of the fourth extension on an opposite side of the third extension and (ii) an end of the first extension on an opposite side to the second extension.

4. The film heater of claim 3, wherein
the wavy section is a first wavy section,
the second connection has a plurality of second wavy sections connected and lined up with each other,
the second wavy section includes:
a fifth extension extending in a direction in which the surface of the transparent conductive film extends;
a sixth extension connected to the fifth extension and extending in a direction that intersects with the direction in which the fifth extension extends;
a seventh extension connected to the sixth extension and extending in a direction that intersects with the direction in which the sixth extension extends; and
an eighth extension connected to the seventh extension and extending in a direction that intersects with the direction in which the seventh extension extends, to face in the direction in which the sixth and fifth extensions extend, and
the plurality of second wavy sections adjacent to each other are connected and lined up by connection of (i) an end of the eighth extension on an opposite side of the seventh extension and (ii) an end of the fifth extension on an opposite side of the sixth extension.

5. The film heater of claim 1, wherein
the film heater is attached to a transparent body that transmits electromagnetic waves,
the transparent body includes a first shield unit and a second shield unit respectively shielding electromagnetic waves,
the first connection overlaps a projected portion of the first shield unit when the first shield unit is projected in the thickness direction, and
the second connection overlaps a projected portion of the second shield unit when the second shield unit is projected in the thickness direction.

6. The film heater of claim 1, wherein
the first electrode includes a first lead connected to the first connection, and a first terminal connected to the first lead and connected to a power source,
the second electrode includes a second lead connected to the second connection, and a second terminal connected to the second lead and to the power source, and
the lengths from the first and second terminals to the first bottom in a direction perpendicular to both of the one direction and the thickness direction are longer than the length of the first bottom in the one direction.

7. The film heater of claim 1, wherein
the film heater is attached to a transparent body that transmits electromagnetic waves,
the transparent body has a first shield unit and a second shield unit that shield electromagnetic waves,
the first electrode includes a first lead connected to the first connection, and a first terminal connected to the first lead and connected to a power source,
the second electrode includes a second lead connected to the second connection, and a second terminal connected to the second lead and to the power source,
the first lead overlaps a projected first shield unit when the first shielding portion is projected in the thickness direction, and
the second lead overlaps a projected second shield unit when the second shield unit is projected in the thickness direction.
